(19) United States
(12) Patent Application Publication
(10) Pub. No.: US 2026/0170927 A1
(43) Pub. Date: Jun. 18, 2026

(54) LOTTERY GAMING SYSTEMS AND METHODS OF OPERATING LOTTERY GAMING SYSTEMS THAT PROVIDE LOTTERY TICKET BOARDS FOR MULTIPLE DRAWINGS OF DRAW LOTTERY GAMES

(71) Applicant: Brightstar Global Solutions Corporation, Providence, RI (US)

(72) Inventors: David Blonstein, Sparks, NV (US); Kyle Rothchild, Carson City, NV (US); Gregory Quinten Williams, Sparks, NV (US)

(21) Appl. No.: 18/982,068

(22) Filed: Dec. 16, 2024

(51) Int. Cl. G07F 17/32

(52) U.S. Cl. CPC G07F 17/329; G07F 17/3225; G07F 17/3269

(57) ABSTRACT

A lottery gaming system and method of operating a lottery gaming system that provide a lottery ticket board and enable purchases of draw lottery tickets for drawings of a draw lottery game and links the draw lottery tickets to the lottery ticket board.

### BACKGROUND

The present disclosure relates to lottery gaming systems and methods of operating lottery gaming systems that provide lottery ticket boards for multiple drawings of draw lottery games.

Lottery gaming systems may enable a player to select numbers for a draw lottery ticket and then randomly select drawn lottery numbers. Lottery gaming systems may provide an award to the player based on the quantity of matches between the drawn lottery numbers and the player-selected numbers.

### BRIEF SUMMARY

In various embodiments, the present disclosure relates to a lottery gaming system including a lottery terminal and a central lottery server comprising a processor and a memory device that stores a plurality of instructions, that when executed by the processor, cause the processor to: provide a lottery ticket board comprising: different additional award symbols, different awards associated with the different additional award symbols, and empty additional match symbol slots; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, a determination of one of the additional award symbols that results in the award associated with that additional award symbol being won, and a determination of an additional match symbol that fills one of the empty additional match symbol slots.

In various other embodiments, the present disclosure relates to a lottery gaming system including a lottery terminal and a central lottery server comprising a processor and a memory device that stores a plurality of instructions, that when executed by the processor, cause the processor to: provide a lottery ticket board comprising: empty additional match symbol slots; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, and a determination of an additional match symbol that fills one of the empty additional match symbol slots.

In various other embodiments, the present disclosure relates to a lottery gaming system including a lottery terminal and a central lottery server comprising a processor and a memory device that stores a plurality of instructions, that when executed by the processor, cause the processor to: provide a lottery ticket board comprising: different additional award symbols, and different awards associated with the different additional award symbols; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, and a determination of one of the additional award symbols that results in the award associated with that additional award symbol being won.

Additional features are described in, and will be apparent from, the following Detailed Description and the figures.

### BRIEF DESCRIPTION OF THE SEVERAL VIEWS OF THE DRAWINGS

FIG. 1 is a flow chart of a method for operating a lottery gaming system of one example embodiment of the present disclosure.

FIG. 2A is a front view of a display device displaying a lottery ticket board provided by a lottery gaming system for a series of drawings of a draw lottery game, wherein the display of the lottery ticket board is at a first point in time in accordance with one example embodiment of the present disclosure.

FIG. 2B is a front view of a display device displaying the lottery ticket board provided by the lottery gaming system for the series of drawings of the draw lottery game of FIG. 2A, and wherein the display of the lottery ticket board is at a second point in time in accordance with one example embodiment of the present disclosure.

FIG. 2C is a front view of a display device displaying the lottery ticket board provided by the lottery gaming system for the series of drawings of the draw lottery game of FIG. 2A, and wherein the display of the lottery ticket board is at a third point in time in accordance with one example embodiment of the present disclosure.

FIG. 2D is a front view of a display device displaying the lottery ticket board provided by the lottery gaming system for the series of drawings of the draw lottery game of FIG. 2A, and wherein the display of the lottery ticket board is at a fourth point in time in accordance with one example embodiment of the present disclosure.

FIG. 3 is a schematic diagram of a lottery gaming system of one example embodiment of the present disclosure.

### DETAILED DESCRIPTION

In various embodiments, the present disclosure relates to lottery gaming systems and methods of operating lottery gaming systems that provide one or more lottery ticket boards for multiple drawings of one or more draw lottery games. Each lottery board connects the multiple drawings of the draw lottery game(s) in one or more different manners and provides additional opportunities for additional awards based on the drawings. In various embodiments, the lottery board provides additional instant awards and/or additional opportunities for matching drawn symbols (such as drawn numbers) in the drawings of the draw lottery game(s). For simplicity, various embodiments of one lottery ticket board for multiple drawings of a single draw lottery game are used herein to describe the present disclosure, but it should be appreciated that such descriptions are not meant to limit the present disclosure.

In various embodiments, each lottery ticket board is provided by a lottery gaming system and is configured for a series of drawings of a draw lottery game (such as a series of drawings of the draw lottery game over a predetermined period of time or such as a sequential series of drawings of the draw lottery game over a predetermined period of time), and for enabling opportunities for additional awards based on a determination of the plurality of drawn symbols from the plurality of drawings of the draw lottery game that correspond to certain additional award symbols (such as additional award numbers) on the lottery ticket board.

In various embodiments, the lottery ticket board includes a plurality of additional award symbols (such as additional award numbers) that are matchable by drawn symbols (such as numbers) for subsequently purchased draw lottery tickets by the player that are linked to the lottery ticket board (as further explained below). When one of the additional award symbols (such as one of the additional award numbers) on the lottery ticket board are matched by a drawn number, the lottery gaming system is configured to provide an additional award to the player. The lottery ticket board thus provides an additional award feature for the draw lottery game and specifically for multiple drawings of the draw lottery game.

In various embodiments, the lottery ticket board additionally or alternatively includes one or more additional match symbol slots (such as one or more additional match number slots). Each of these additional match symbol slots can be filled with a drawn symbol (such as a drawn number) determined during or in association with a drawing for the draw lottery game. The addition match symbols (such as the additional match numbers) accumulated in these additional match symbol slots of the lottery ticket board are subsequently employable by the lottery gaming system to provide additional matches of drawn symbols (such as drawn numbers) of one or more subsequent drawings of the draw lottery game, and thus additional awards for those drawings based on such additional matches.

In various embodiments, for each drawing of a draw lottery game that is associated with the lottery ticket board, the lottery gaming system can determine zero, one, or more of a first type of drawn award symbol indicators (such as drawn award number indicators) for that drawing. The lottery ticket system can then employ those drawn award symbol indications (such as drawn award number indicators) of the first type in relation to the lottery ticket board such as for determining matches with the additional award symbols (such as the additional award numbers) on the lottery ticket board and awards associated with those matches.

In various examples, for each drawing of a draw lottery game that is associated with the lottery ticket board, the lottery gaming system can determine zero, one, or more of a second type of drawn match symbol indicators (such as drawn match number indicators) that can provide additional match symbols (such as additional match numbers) for the additional match symbol slots (such as the additional match number slots) of the lottery ticket board.

In various embodiments, the lottery gaming system is configured to provide the lottery ticket board to the player in a physical format such as on a substrate with the various components of lottery ticket board (described below) printed on the substrate.

In various embodiments, the lottery gaming system is configured to provide the lottery ticket board to the player in an electronic format with the various components of the lottery ticket board displayable by a display device of a player electronic device (“PED”) used by the player to access the lottery ticket board. In various such embodiments, the lottery gaming system is configured to provide and enable the display device of the PED to display updated information regarding additional award symbols, additional match symbols, matches of any additional award symbols and resulting awards, additional matches of any drawn symbols and any awards won based on such additional matches for each drawing of the series of drawings of the draw lottery game that is linked to the lottery ticket board.

In various embodiments, the lottery gaming system is configured to require a player to purchase the lottery ticket board for a predetermined amount such as one of a plurality of different predetermined amounts.

In various embodiments, the lottery ticket board is configured for multiple drawings of a single draw lottery game.

In various embodiments, the lottery ticket board is configured for multiple sequential drawings of a single draw lottery game.

In various embodiments, the lottery ticket board is configured for any combination of drawings of a single draw lottery game over a predetermined period of time (such as a month or a year).

In various embodiments, the lottery ticket board is configured for multiple drawings of more than one draw lottery game.

In various embodiments, the lottery ticket board is configured for multiple sequential drawings of more than one draw lottery game.

In various embodiments, the lottery ticket board is configured for any combination of drawings of more than one draw lottery game.

In various embodiments, the lottery ticket board includes a series of additional award symbols such as additional award numbers. Award numbers are used as the primary example of the award symbols on the lottery ticket board to explain the present disclosure, but it should be appreciated that such examples using numbers are not meant to limit the present disclosure.

In various embodiments, the lottery ticket board includes a series of additional match symbol slots such as additional match number slots. Match number slots are used as the primary example of the match symbol slots on the lottery ticket board to explain the present disclosure, but it should be appreciated that such examples using numbers are not meant to limit the present disclosure.

In various embodiments, the lottery ticket board includes additional match numbers that correspond to all of the possible drawable numbers of a draw lottery game.

In various embodiments, the lottery ticket board includes additional match numbers that correspond to less than all of the possible drawable numbers of a draw lottery game.

In various embodiments, the lottery ticket board includes additional match numbers that correspond to all of the possible drawable numbers of a draw lottery game, and one or more additional instances of one or more of the possible drawable numbers of the draw lottery game.

In various embodiments, the lottery ticket board includes additional match numbers that correspond to certain of the possible drawable numbers of a draw lottery game but not one or more other of the possible drawable numbers of the draw lottery game.

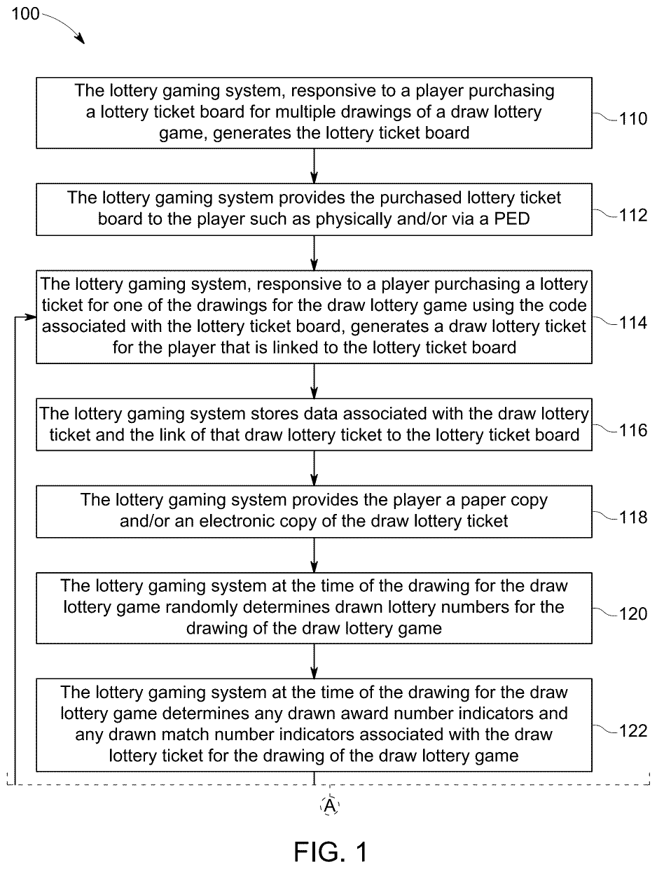

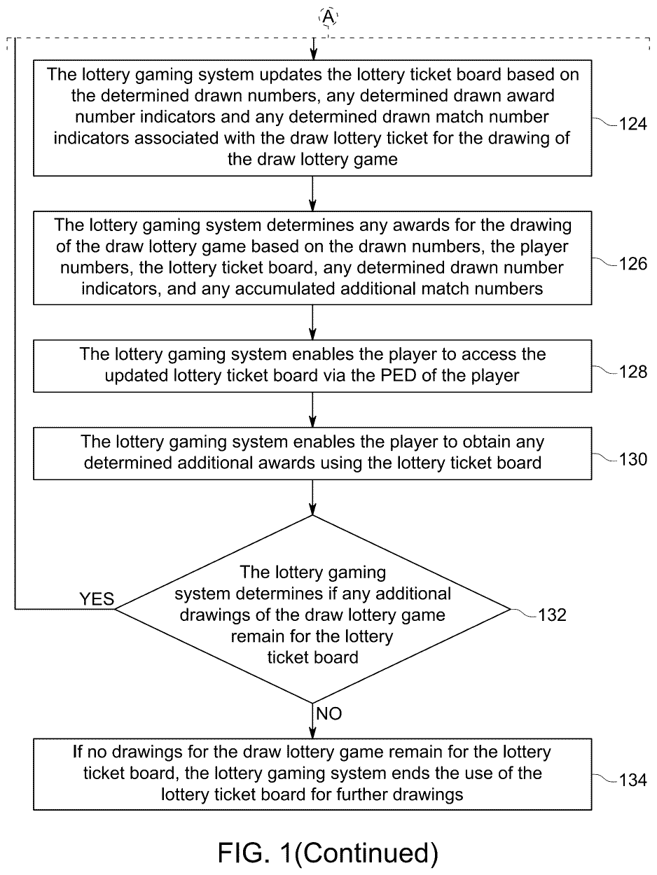

FIG. 1 is a flowchart of an example method (indicated by numeral 100) of operating an example lottery gaming system of the present disclosure. In various embodiments, the method 100 is represented by a set of instructions stored in one or more memory devices and executed by one or more processors. Although the method 100 is described with reference to the flowchart shown in FIG. 1, other processes of performing the acts associated with this illustrated example method can be employed. For example, the order of certain of the illustrated blocks and/or diamonds may be changed, certain of the illustrated blocks and/or diamonds may be optional, or certain of the illustrated blocks and/or diamonds may not be employed.

The lottery gaming system, responsive to a player purchasing a lottery ticket board for multiple drawings of a draw lottery game, generates the lottery ticket board, as indicated by block 110. The lottery ticket board is associated with a lottery ticket board identifier and includes a code (such as a bar code or QR code) that enables the purchase of lottery tickets for drawings of a draw lottery game that are linked to the lottery ticket board. In other words, when a player want to buy a lottery ticket and link that lottery ticket to the lottery ticket board, the player can have the code of the lottery ticket board scanned in by the lottery terminal and the lottery gaming system can link that lottery ticket to the lottery ticket board.

As indicated above, in various embodiments, the multiple drawings for the draw lottery game can be during a predetermined time period and/or can be for a predetermined quantity of drawings of a draw lottery game. The quantity of drawings that the lottery ticket board can be employed for can be determined in any suitable manner and can be based on the purchase price for the lottery ticket board.

As indicated above, in various embodiments, the lottery gaming system determines the quantity of additional award numbers on the lottery ticket board and the additional award numbers on the lottery ticket board. The quantity of additional award numbers that the lottery ticket board can be employed for can be determined in any suitable manner and can be based on the purchase price for the lottery ticket board.

As indicated above, in various embodiments, the lottery gaming system determines the quantity of additional match number slots on the lottery ticket board. The quantity of additional match number slots that the lottery ticket board can be employed for can be determined in any suitable manner and can be based on the purchase price for the lottery ticket board.

In various embodiments, the lottery gaming system determines the respective awards associated with the additional award number on the lottery ticket board. The awards can be determined in any suitable manner and can be based on the purchase price for the lottery ticket board.

In various embodiments, one or both of these quantities as well as the awards associated with the additional award numbers can vary based on the purchase amount required for the lottery tickets board. For example, a relatively lower purchase amount can result in relatively less additional award numbers and/or less additional match number slots, and a relatively higher purchase amount can result in relatively more additional award numbers and/or more additional match number slots.

In various embodiments, since the player purchases the lottery ticket board, the player is incentivized to use the lottery ticket board and thus to purchase lottery tickets for the drawings of the draw lottery game that can be associated with the lottery ticket board to maximize awards resulting from the lottery ticket board.

In various other embodiments, the lottery ticket board does not need to be purchased by the player, but rather can be provided to a player to otherwise incentivize the player to purchase lottery tickets for the drawings of the draw lottery game that can be associated with the lottery ticket board to potentially obtain extra awards resulting from the lottery ticket board.

The lottery gaming system provides the purchased lottery ticket board to the player such as physically and/or via a PED, as indicated by block 112. The lottery gaming system enables the player to access (via the PED) the lottery ticket board and updates to the lottery ticket board made by the lottery gaming system at any desired time.

The lottery gaming system, responsive to a player purchasing a lottery ticket for one of the drawings for the draw lottery game using the code associated with the lottery ticket board, generates a draw lottery ticket for the player that is linked to the lottery ticket board, as indicated by block 114.

In various embodiments, the lottery gaming system enables the player to select the player's numbers for the draw lottery ticket for the drawing for the draw lottery game in any suitable manner. In various embodiments, the determined player numbers for the draw lottery ticket for the drawing of the draw lottery game are directly selected by the player. In various other embodiments, the determined player numbers for the draw lottery ticket for the drawing of the draw lottery game are randomly selected by the lottery gaming system at the request of the player (such as via a quick pick process).

The lottery gaming system stores data associated with the draw lottery ticket and the link of that draw lottery ticket to the lottery ticket board, as indicated by block 116.

The lottery gaming system provides the player a paper copy and/or an electronic copy of the draw lottery ticket, as indicated by block 118. In various embodiments, the draw lottery ticket can indicate an association with the lottery ticket board.

The lottery gaming system at the time of the drawing for the draw lottery game randomly determines drawn lottery numbers for the drawing of the draw lottery game, as indicated by block 120.

The lottery gaming system at the time of the drawing for the draw lottery game determines any drawn award number indicators and any drawn match number indicators associated with the draw lottery ticket for the drawing of the draw lottery game, as indicated by block 122. The lottery gaming system can determine any of these drawn award number indicators and any drawn match number indicators associated with the drawing in a random manner or in another suitable manner such as based on a predetermined schedule.

The lottery gaming system updates the lottery ticket board based on the determined drawn numbers, any determined drawn award number indicators, and any determined drawn match number indicators associated with the draw lottery ticket for the drawing of the draw lottery game, as indicated by block 124.

The lottery gaming system determines any awards for the drawing of the draw lottery game based on the drawn numbers, the player numbers, the lottery ticket board, any determined drawn award number indicators, and any accumulated additional match numbers, as indicated by block 126.

In various embodiments, this determination includes a determination of any awards for the drawing of the draw lottery game based on the quantity of matches between the player numbers and the drawn lottery numbers for that drawing of the draw lottery game.

In various embodiments, this determination also includes a determination of any awards based on the lottery ticket board, and particularly: (1) a determination of any awards associated with any of the additional award symbols on the lottery ticket board that match any of the drawn award symbol indicators; and (2) any drawn numbers that match any accumulated additional match numbers.

In various embodiments, the awards can be static awards, can be in static ranges, can be in changeable ranges, or can be otherwise changeable. In various embodiments, the changeable awards can be progressive awards, pari-mutuel awards, or other suitable changeable awards. In various embodiments, the awards can be static or changeable based on the wager level of the player, or otherwise.

The lottery gaming system enables the player to access the updated lottery ticket board via the PED of the player, as indicated by block 128.

The lottery gaming system enables the player to obtain any determined additional awards using the lottery ticket board, as indicated by block 130.

The lottery gaming system determines if any additional drawings of the draw lottery game remain for the lottery ticket board, as indicated by diamond 132.

If any drawings for the draw lottery game remain for the lottery ticket board, the lottery gaming system returns to block 114.

If no drawings for the draw lottery game remain for the lottery ticket board, the lottery gaming system ends the use of the lottery ticket board for further drawings, as indicated by block 134.

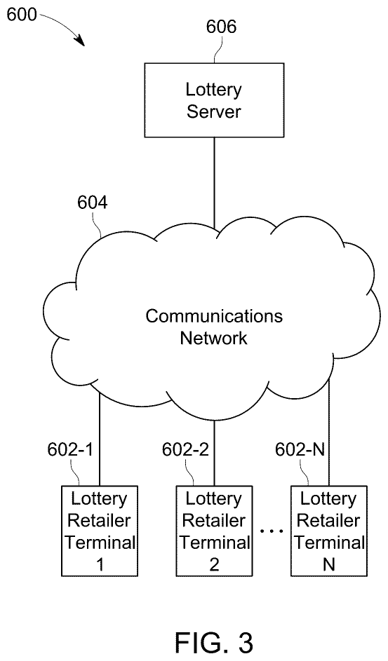

In various embodiments, the lottery gaming system enables the player to purchase the lottery ticket board for the drawings of the draw lottery game via any suitable manner such as, but not limited to, one of the following: (1) a dedicated lottery kiosk (e.g., a lottery kiosk) configured to communicate over a data network (such as the Internet) to a lottery server (such as a lottery server 606 described below in connection with FIG. 3); (2) a retailer-operated lottery terminal configured to communicate over a data network (such as the Internet) to a lottery server (such as a lottery server 606 described below in connection with FIG. 3); and/or (3) a PED such as a personal computer configured to communicate over a data network (such as the Internet) to a lottery server (such as a lottery server 606 described below in connection with FIG. 3) or such as a cellular telephone, a tablet, a smart phone, or other suitable device configured to communicate over a data network (such as a wireless or cellular data network) to a lottery server (such as a lottery server 606 described below in connection with FIG. 3).

In various embodiments, the lottery gaming system enables the player to purchase the lottery tickets linked to the lottery ticket board for the drawings of the draw lottery game via any suitable manner such as, but not limited to, one of the following: (1) a dedicated lottery kiosk (e.g., a lottery kiosk) configured to communicate over a data network (such as the Internet) to a lottery server (such as a lottery server 606 described below in connection with FIG. 3); (2) a retailer-operated lottery terminal configured to communicate over a data network (such as the Internet) to a lottery server (such as a lottery server 606 described below in connection with FIG. 3); and/or (3) a PED such as a personal computer configured to communicate over a data network (such as the Internet) to a lottery server (such as a lottery server 606 described below in connection with FIG. 3) or such as a cellular telephone, a tablet, a smart phone, or other suitable device configured to communicate over a data network (such as a wireless or cellular data network) to a lottery server (such as a lottery server 606 described below in connection with FIG. 3). In one such example embodiment, the lottery gaming system enables a player to use a paper playslip to purchase a lottery ticket at a retail location having a lottery terminal configured to receive the playslip and print the lottery ticket at the time of purchase in a conventional manner. In such lottery gaming systems, the retail operator can receive the purchase price for the lottery ticket from the player in a conventional manner. In another such example embodiment, the lottery gaming system enables a player to use a virtual playslip to purchase a lottery ticket through a retail lottery kiosk configured to display the playslip (as further described below), receive the player number selections using the displayed playslip (as further described below), receive the wager from the player, and print the lottery ticket at the time of purchase. This example lottery kiosk may include an integral printer device and/or be in communication with a printer device for providing a printed lottery ticket to the player. In another such example embodiment, the lottery gaming system enables a player to use a virtual playslip to purchase a lottery ticket electronically using a PED. In one such embodiment, the lottery gaming system receives from this device the player number selections and the wager from the player, and sends the player a virtual lottery ticket (which in certain instances can be printed by the player using a suitable personal printing device). Thus, it should be appreciated that in various example embodiments, the player may purchase a lottery ticket with a PED, and, thus, may not be provided with a physical (i.e., paper) lottery ticket. Instead, an electronic (or virtual) version of the lottery ticket is provided to the player via, for example, an electronic mail to an email account associated with the player.

In various embodiments, for each lottery ticket purchased that is linked to the lottery ticket board, the lottery gaming system creates a data record corresponding to that lottery ticket and the link to that lottery ticket board. For example, when a lottery terminal is used to purchase a lottery ticket linked to a lottery ticket board, the lottery gaming system creates a data record including suitable information such as but not limited to: (1) a timestamp (date and/or time) associated with when the lottery ticket was purchased; (2) an identification number that matches the lottery ticket with the lottery ticket board; (3) the player-selected wager amount for the drawing of the draw lottery game; (4) the lottery ticket identification number; and/or (5) any other suitable information. In various embodiments, this data record is created by the lottery terminal and sent by the lottery terminal to the lottery server (such as described below in connection with the lottery server 606 of FIG. 3). It should be appreciated that the lottery ticket data record can be otherwise suitably created in accordance with the present disclosure.

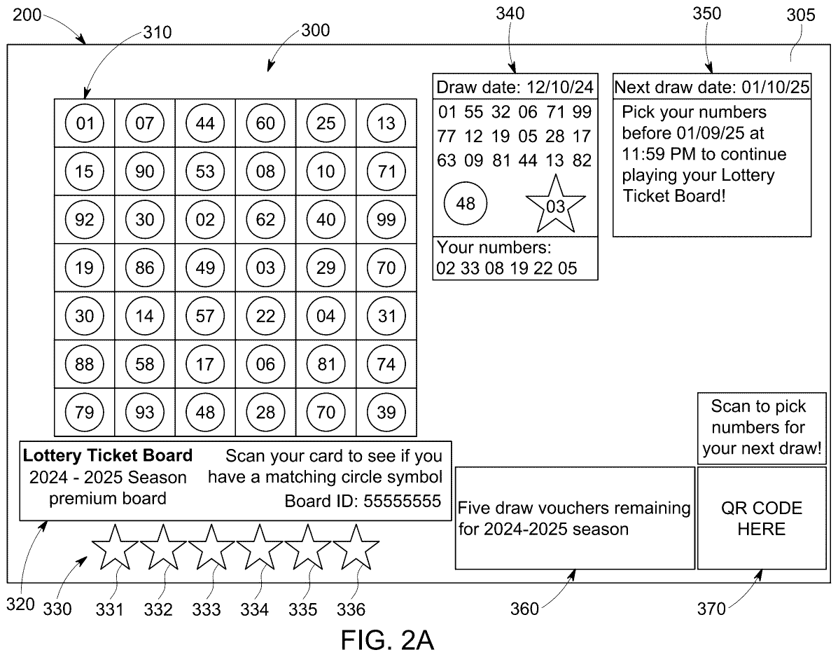

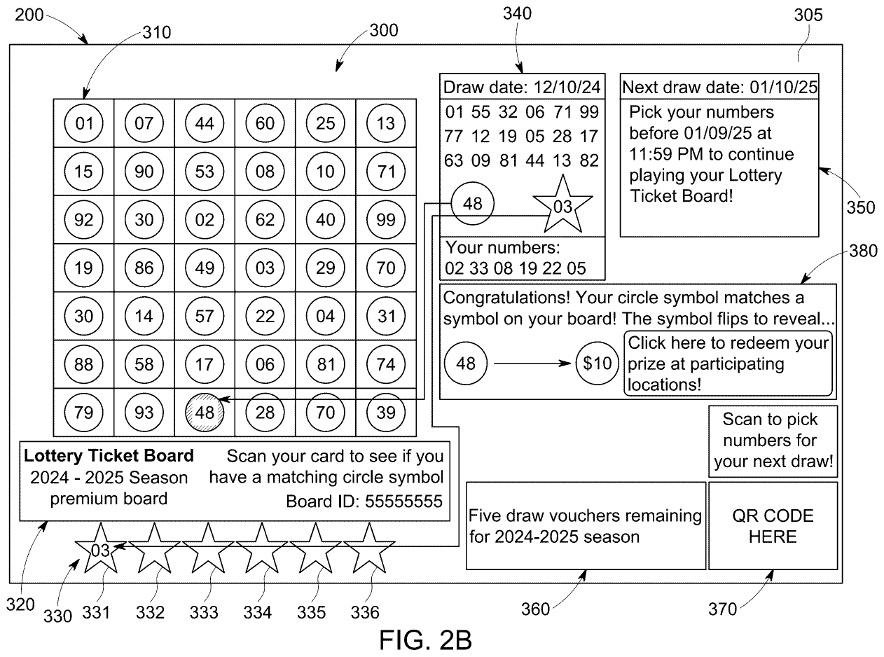

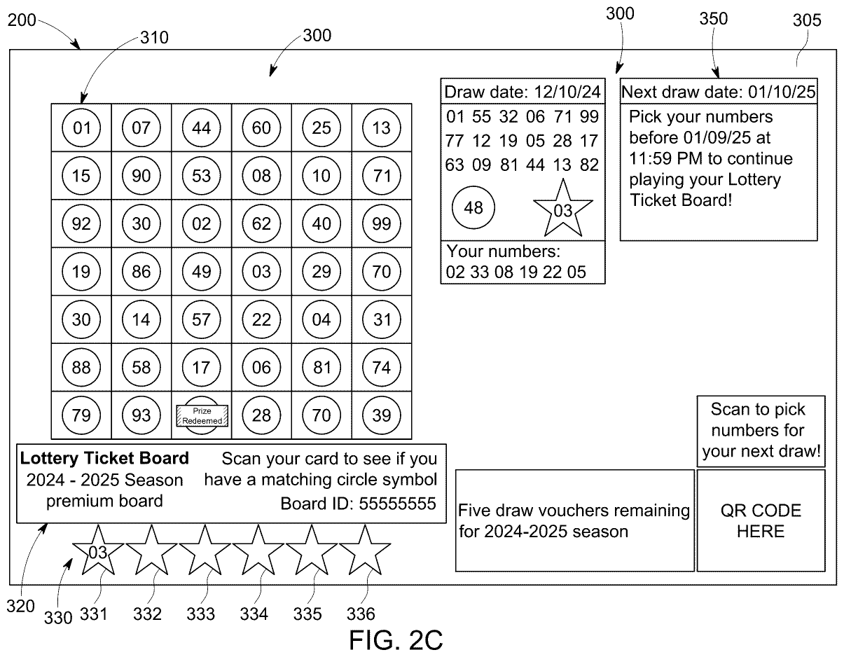

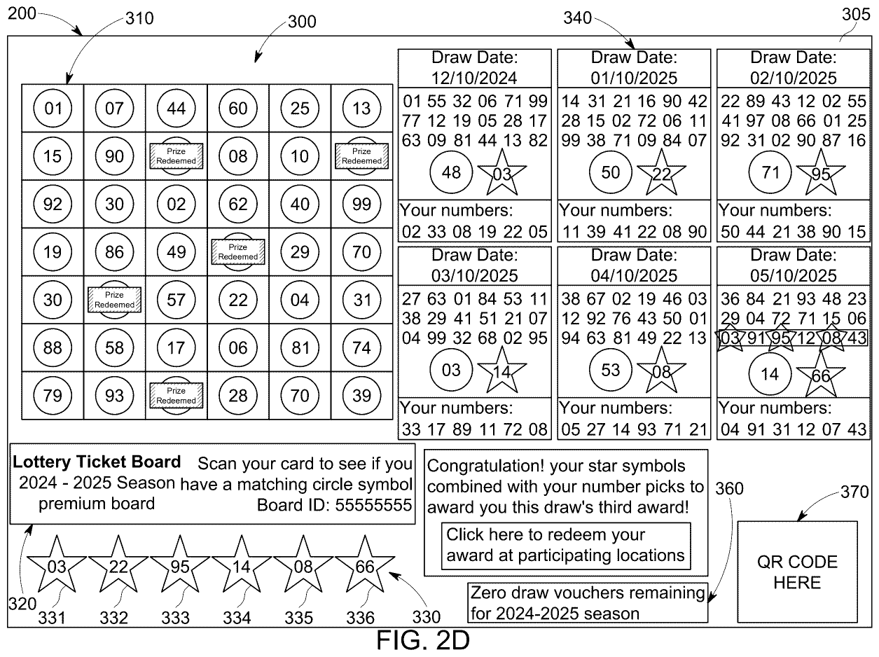

FIGS. 2A, 2B, 2C, and 2D illustrate a display device 500 displaying an example lottery ticket board, updates to the lottery ticket board based on drawings of the draw lottery game, indications of player numbers and drawn numbers for drawings of the draw lottery game, indications of additional award numbers, indications of additional match number slots, indications of drawn award number indicators, indications of drawn match number indicators, and indications of additional awards based on same, all in accordance with one example embodiment of the present patent application.

More specifically, FIG. 2A shows a display device 200 of a PED displaying an example lottery ticket board 300. The lottery ticket board 300 includes: (1) a background 305 (that can be a substrate in the physical embodiments of the lottery ticket board); (2) an additional award symbol area such as an additional award numbers area 310 on the background 305; (3) an information area 320 on the background 305; (4) an additional match symbol slot area such as an additional match number slot area 330 on the background 305; (5) a lottery ticket and drawing area 340 on the background 305; (6) a next draw indicator 350 on the background 305; (7) a remaining draws indicator 360 on the background 305; (8) a lottery ticket board code indicator 370 on the background 305; and (9) an award indicator area 380 on the background 305. Each of these areas can be any suitable size and shape and can be configured and positioned on the background 305 in any suitable manner in accordance with the present disclosure.

The additional award numbers area 310 indicates the additional award numbers of the lottery ticket board 300. The quantity of additional award numbers can vary in accordance with the present disclosure.

The information area 320 indicates the time period for the lottery ticket board, the lottery ticket board identifier such as the Board ID number, and any other suitable information.

The additional match number slot area 330 indicates each of the available additional match number slots (such as example additional match number slots 331, 332, 333, 334, 335, and 336).

The lottery ticket and drawing area 340 indicates information regarding each of the drawings and the player's lottery tickets for those drawings including the drawing date, the player numbers, the drawn numbers, the drawn award number indicator(s), and the drawn match number indicator(s) associated with that drawing.

The next draw indicator 350 indicates the next drawing date for the draw lottery game and the deadline for the player to purchase a lottery ticket for that next drawing for the draw lottery game using the lottery ticket board.

The remaining draws indicator 360 indicates the quantity of remaining drawings for the draw lottery game that the lottery ticket board can be used for.

The lottery ticket board code indicator 370 indicates a code that can be used to associate the lottery ticket board with a lottery ticket to be purchased by the player.

The award indicator area 380 indicates any awards resulting from any drawings of the draw lottery game and/or the lottery ticket board.

As shown in FIG. 2A, in this example, (1) the lottery ticket board 300 includes 42 additional award numbers (not individually labeled) as shown in the additional award numbers area 310; and (2) six available additional match number slots 331, 332, 333, 334, 335, and 336 as shown in the additional match number slot area 330. In this example, the lottery ticket board 300 includes a total of six drawings for the 2024-2025 season time period. In this example, this lottery ticket board 300 has been associated by the player a first lottery ticket for a first drawing on Dec. 10, 2024, and thus five of the six drawings for the 2024-2025 season time period remain as indicated by the remaining draws indicator 360 in FIG. 2A.

In this example, for the first lottery ticket and the first drawing on Dec. 10, 2024 that is associated with the lottery ticket board 300, the player's numbers are 02, 33, 08, 19, 22, and 05 for the player's lottery ticket, and the randomly drawn numbers are 01, 55, 32, 06, 71, 99, 77, 12, 19, 05, 28, 17, 63, 09, 81, 44, 13, and 82. These drawn numbers and the player's numbers only result in one match and thus do not result in any award provided to the player for such quantity of matches.

In this example, the first drawing on Dec. 10, 2024 that is associated with the lottery ticket board 300 also results in the circled additional award number indicator 48 and the starred additional match number indicator 03. In this example, these numbers are randomly determined by the lottery gaming system.

As further shown in FIG. 2B, the circled additional award number indicator 48 matches the 48 on the additional award number on the board 300 and the match results in an award of $10 (which is the additional award associated with the additional award number 48 on the board 300) being won by the player. As further shown in FIG. 2C, after the circled additional award number indicator 48 matches the additional award number 48 on the lottery ticket board 300, the additional award number 48 on the lottery ticket board 300 is considered won and not again winnable by the player in this example embodiment.

As also shown in FIG. 2B, the starred additional match number 03 is placed in the first additional match number slot 331 (of the six available additional match number slots 331, 332, 333, 334, 335, and 336). This additional match number 03 can be subsequently used for matching a drawn number in subsequent drawings (such as described below).

Thus, for this example lottery ticket and example drawing, even though the lottery ticket did not result in an award based on the matches between the player's numbers and the drawn numbers, the link of the lottery ticket to the lottery ticket board resulted in the award of $10 and the accumulated drawn award number 03 that can lead to subsequent matches.

FIG. 2D shows the lottery ticket board 300 at a subsequent time after the player has purchased five additional lottery tickets for five more draws of the draw lottery game and has linked those five additional lottery tickets to the lottery ticket board 300.

In this example, the second lottery ticket the player linked to the lottery board 300 and the additional drawing on Jan. 10, 2025 resulted in: (1) the circled additional award number indicator 50 that did not match any of the additional award numbers on the lottery ticket board 300 and thus did not result in an additional award; and (2) the starred additional match number 22 that was added to the second additional match number slot 332.

In this example, the third lottery ticket the player linked to the lottery board 300 and the additional drawing on Feb. 10, 2025 resulted in: (1) the circled additional award number indicator 71 that matched the additional award number 71 on the lottery ticket board and thus resulted in an additional award that was associated with the additional award number 71 on the lottery ticket board 300; and (2) the starred additional match number 95 that was added to the third additional match number slot 333.

In this example, the fourth lottery ticket the player linked to the lottery board 300 and the additional drawing on Mar. 10, 2025 resulted in: (1) the circled additional award number indicator 03 that matched the additional award number 03 on the lottery ticket board and thus resulted in an additional award that was associated with the additional award number 03 on the lottery ticket board 300; and (2) the starred additional match number 14 that was added to the fourth additional match number slot 334.

In this example, the fifth lottery ticket the player linked to the lottery board 300 and the additional drawing on Apr. 10, 2025 resulted in: (1) the circled additional award number indicator 53 that matched the additional award number 53 on the lottery ticket board and thus resulted in an additional award that was associated with the additional award number 53 on the lottery ticket board 300; and (2) the starred additional match number 08 that was added to the fifth additional match number slot 335.

In this example, the sixth lottery ticket the player linked to the lottery board 300 and the additional drawing on May 10, 2025 resulted in: (1) the circled additional award number indicator 14 that matched the additional award number 14 on the lottery ticket board and thus resulted in an additional award that was associated with the additional award number 14 on the lottery ticket board 300; and (2) the starred additional match number 66 that was added to the sixth additional match number slot 336.

In this example, the accumulated additional match numbers 03, 95, and 08 in the additional match number slots 331, 333, and 335 match three of the drawn numbers from the drawing on May 10, 2025, which results in an additional award (not indicated) based on these three matches in accordance with the draw lottery game.

In this example, only accumulated additional match numbers in the additional match number slots are used to match the drawn numbers from the drawing.

In various embodiments, one or more or all of the accumulated additional match numbers in the additional match number slots are useable with one or more or all of the player numbers from a draw lottery ticket to match the drawn numbers from the drawing for that draw lottery ticket.

In various embodiments, one or more or all of the accumulated additional match numbers in the additional match number slots are not useable with one or more or all of the player numbers from a draw lottery ticket to match the drawn numbers from the drawing for that draw lottery ticket.

In various other embodiments, the lottery gaming system can provide more than one type of drawn match number indicators that are respectively usable together. For example, gold star drawn match number indicators can only be used in conjunction with other gold star drawn match number indicators for matching drawn numbers in a drawing of the draw lottery game, and silver star drawn match number indicators can only be used in conjunction with other silver star drawn match number indicators for matching drawn numbers in a drawing of the draw lottery game.

In various other embodiments, multiple lottery ticket boards can be employed together. In certain examples, drawn match number indicators can be accumulated on two or more lottery ticket boards and used together to match drawn numbers for a drawing for the draw lottery game. In other examples, the lottery ticket boards can be configured such that one or more of the awards associated with the additional award symbols on the lottery ticket boards can be revealed if a suitable combination of drawn award symbol indicators occur.

In various other embodiments, an accumulated drawn match number can be applied by the player to an additional award number on the lottery ticket board to obtain an award associated with the additional award number indicator.

In various other embodiments, only certain types of an accumulated drawn match number can be applied by the player to an additional award number on the lottery ticket board to obtain an award associated with the additional award number. For example, gold star drawn match number indicators can be used in such manner but silver star drawn match number indicators can not be used in such manner.

In various other embodiments, the lottery gaming system can provide additional awards if certain combinations of the additional award symbols on the lottery ticket board are matched by drawn award symbol indicators. For example, the lottery gaming system can provide: (1) an additional award if a row of the additional award symbols on the lottery ticket board are matched by drawn award symbol indicators; (2) an additional award if a column of the additional award symbols on the lottery ticket board are matched by drawn award symbol indicators; and/or (3) an additional award if all of the additional award symbols on the lottery ticket board are matched by drawn award symbol indicators.

In various other embodiments, the lottery ticket board can have an expiration date (that can be indicated on the lottery ticket board), and the lottery ticket board would need to be linked to lottery tickets before such expiration date for the player to possibly win the awards associated with that lottery ticket board.

In various other embodiments, the lottery ticket board includes one or more awards that require one or more unique combinations of drawn award symbol indicators.

In various other embodiments, the lottery ticket board includes one or more awards whose values increase based on one or more unique combinations of drawn award symbol indicators.

In various other embodiments, the lottery ticket board includes one or more additional award symbols on the lottery ticket board that can increase the amount of an award based on one or more of the matches between the player numbers and the drawn numbers for a draw lottery ticket for a drawing of the draw lottery game. The increase can be a total additional static amount (e.g., $200), an additional static amount (e.g., $50) per match, or a suitable multiplier (such as 3×).

In various other embodiments, the accumulated drawn match symbols are stored by the lottery gaming system even if a paper version of the lottery ticket board is provided to the player.

In various other embodiments, the lottery gaming system enables a player to exchange one or more of their accumulated drawn match symbols via the lottery gaming system for one or more other available accumulated drawn match symbols. For example, the lottery gaming system can enable a player to exchange an accumulated drawn match symbol 15 for an accumulated drawn match symbol 35.

In various other embodiments, the lottery gaming system enables players to trade their accumulated match symbols via the lottery gaming system (or via another suitable system). For example, the lottery gaming system can enable a player to trade an accumulated drawn match symbol 45 for an accumulated drawn match symbol 32.

In various other embodiments, the lottery gaming system enables a player to buy one or more additional accumulated match symbols via the lottery gaming system for one or more subsequent draw lottery tickets for one or more drawings of the draw lottery game.

In various other embodiments, the lottery gaming system enables a player to purchase an additional allotment of time and/or quantity of drawings for the lottery ticket board such that the accumulated drawn match symbols of the lottery ticket board can be used for additional linked draw lottery ticket drawings for the draw lottery game.

In various other embodiments, the lottery gaming system enables the player to cash in one or more additional accumulated match symbols such as for a consolation award.

In various other embodiments, the lottery gaming system enables a player to transfer one or more accumulated drawn match symbols to another lottery ticket board or to a future lottery ticket board to be purchased by the player.

In various other embodiments, the lottery gaming system configures the lottery ticket board to provide one or more additional features such as to enable the player to “opt out” or “double up” on accumulated drawn match symbols.

In various other embodiments, the lottery gaming system can provide the lottery ticket board with one or more extra features that are useable with one or more draw lottery tickets that are linked to that lottery ticket board. For example, in various embodiments, the lottery gaming system can provide the lottery ticket board with one or more extra symbols and can provide one or more draw lottery tickets with one or more corresponding extra symbols. The lottery gaming system can provide one or more extra awards that are not based on the player's numbers or any of the drawn numbers, but rather based on matches of one or more of the extra symbols on the lottery ticket board and the draw lottery tickets linked to that lottery ticket board. In one such example, a lottery ticket board includes a set of extra symbols including: a red cherry, a green pear, a yellow banana, an orange tangerine, and purple grapes. The player can buy a draw lottery linked to that lottery ticket board, and the draw lottery ticket can include a red cherry printed on the draw lottery ticket matches the first symbol on the draw lottery board. In certain embodiments, the lottery gaming system can provide an award for such single extra symbol matches, or can provide an award if more than one (such as all) of the extra symbols are matched on one or more linked draw lottery tickets. In various embodiments, the player uses this linked draw lottery ticket with other linked draw lottery tickets featuring other extra symbols (such as until all five are collected), and the lottery gaming system can provide an award associated with all of the collected extra symbols.

It should be appreciated from the above that various embodiments of the present disclosure provide a lottery gaming system including a lottery terminal and a central lottery server. The central lottery server is configured to provide a lottery ticket board comprising: different additional award symbols, different awards associated with the different additional award symbols, and empty additional match symbol slots; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, a determination of one of the additional award symbols that results in the award associated with that additional award symbol being won, and a determination of an additional match symbol that fills one of the empty additional match symbol slots. In various such embodiments, the lottery ticket board comprises a next draw indicator, a remaining draws indicator, and a lottery ticket board code indicator. In various such embodiments, the lottery ticket board is associated with payment of a purchase price for the lottery ticket board. In various such embodiments, the lottery ticket board is associated with drawings for the draw lottery game during a predetermined time period, wherein for each said drawing, a draw lottery ticket for that drawing is linkable to the lottery ticket board. In various such embodiments, the lottery ticket board is associated with a limited quantity of drawings for the draw lottery game, wherein for each said drawing, a draw lottery ticket for that drawing is linkable to the lottery ticket board. In various such embodiments, the lottery ticket board is associated with drawings for the draw lottery game on specific dates, wherein for each said drawing, a draw lottery ticket for that drawing is linkable to the lottery ticket board. In various such embodiments, each additional match symbol that fills one of the empty additional match symbol slots is usable to match a drawn symbol for a subsequent drawing of the draw lottery game. In various such embodiments, one of the additional match symbols that fills one of the empty additional match symbol slots is usable with one of the player numbers of a subsequently purchased lottery ticket to match drawn symbols for a subsequent drawing of the draw lottery game. In various such embodiments, the determination of one of the additional award symbols that results in the award associated with that additional award symbol being won, and the determination of the additional match symbol that fills one of the empty additional match symbol slots are separate from the random determination of drawn symbols.

It should further be appreciated from the above that various embodiments of the present disclosure provide a lottery gaming system including a lottery terminal and a central lottery server. The central lottery server is configured to provide a lottery ticket board comprising empty additional match symbol slots; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, and a determination of an additional match symbol that fills one of the empty additional match symbol slots. In various such embodiments, the lottery ticket board comprises a next draw indicator that indicates a date for the next drawing for the draw lottery game, wherein an additional draw lottery ticket for that next drawing is linkable to the lottery ticket board. In various such embodiments, the lottery ticket board comprises a remaining draws indicator that indicates a quantity of remaining drawings for the draw lottery game, wherein additional draw lottery tickets for the quantity of remaining drawings for the draw lottery game are linkable to the lottery ticket board. In various such embodiments, the lottery ticket board comprises a lottery ticket board code indicator that is readable to enable linking of the draw lottery ticket to the lottery ticket board. In various such embodiments, each additional match symbol that fills one of the empty additional match symbol slots is usable to match a drawn symbol for a subsequent drawing of the draw lottery game. In various such embodiments, one of the additional match symbols that fills one of the empty additional match symbol slots is usable with one of the player numbers of a subsequently purchased lottery ticket to match drawn symbols for a subsequent drawing of the draw lottery game. In various such embodiments, the determination of one of the additional award symbols that results in the award associated with that additional award symbol being won, and the determination of the additional match symbol that fills one of the empty additional match symbol slots are separate from the random determination of drawn symbols.

It should further be appreciated from the above that various embodiments of the present disclosure provide a lottery gaming system including a lottery terminal and a central lottery server. The central lottery server is configured to provide a lottery ticket board comprising: different additional award symbols, and different awards associated with the different additional award symbols; and enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises: a random determination of drawn symbols, and a determination of one of the additional award symbols that results in the award associated with that additional award symbol being won. In various such embodiments, the lottery ticket board is associated with drawings for the draw lottery game during a predetermined time period, wherein for each said drawing, a draw lottery ticket for that drawing is linkable to the lottery ticket board. In various such embodiments, the lottery ticket board is associated with a limited quantity of drawings for the draw lottery game, wherein for each said drawing, a draw lottery ticket for that drawing is linkable to the lottery ticket board. In various such embodiments, the lottery ticket board is associated with drawings for the draw lottery game on specific dates, wherein for each said drawing, a draw lottery ticket for that drawing is linkable to the lottery ticket board.

It should also be appreciated from the above that the present disclosure improves lottery gaming technology in part by providing: (1) new ways to connect different drawings of draw lottery games; (2) new ways for players to interact with lottery gaming systems; (3) new ways to win awards that are based on a single drawing for a draw lottery game; (4) new ways to win awards that are based on multiple drawings of a draw lottery game; and (5) new lottery ticket boards that are linkable to draw lottery tickets for drawings of a lottery game.

### Example Lottery Gaming Systems—General

As mentioned above, in various embodiments, the lottery gaming system and method of the present disclosure are configured to be operated by a lottery agency (such as a state lottery agency).

As mentioned above, in various other embodiments, the lottery gaming system and method of the present disclosure are configured to be operated by a third party that runs the lottery for a lottery agency (such as a state lottery agency).

FIG. 3 illustrates an example networked lottery gaming system 600 for such implementation. This example network lottery gaming system 600 generally includes: (1) a plurality of lottery retailer terminals 602-1 to 602-N; (2) a communications network 604; and (3) one or more lottery servers such as lottery server 606. Generally, the retailer terminals 602-1 to 602-N and the lottery server 606 are configured to perform the functions described above and further described below.

In this example embodiment, each retailer terminal 602 corresponds to (or is associated with) a particular lottery retailer. For example, the first retailer terminal 602-1 of FIG. 3 may be associated with a first lottery retailer, such as a convenience store, and the second retailer terminal 602-2 of FIG. 3 may be associated with a second lottery retailer, such as a supermarket. It should be understood that any suitable quantity of lottery retailer terminals may be employed in the lottery gaming system 600, along with any suitable quantity of corresponding lottery servers 606.

In various example embodiments, the lottery retailer terminal 602 includes one or more processor(s). Generally, the processor is operative to perform or process instructions, and in particular, to operate in accordance with the various methods described herein. For example, the processor of the lottery retailer terminal 602 may be operable to enable the lottery retailer terminal 602 to transmit data to (and receive data from) the lottery server 606. More specifically, the processor may enable the transmission of data representing each lottery ticket.

In various example embodiments, the lottery retailer terminal 602 includes one or more input device(s). The input devices of the lottery retailer terminal 602 may include components such as an optical scanner and/or a barcode scanner, for reading and/or for deriving information associated with a playslip and/or a lottery ticket. For example, a lottery ticket may include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of the lottery retailer terminal 602 may include a clock. The clock may be employed to detect, derive and/or append time and/or date information for use by the lottery server 606 to: (i) create a data record corresponding to lottery tickets purchased at the lottery retailer terminal 602, (ii) to determine redemption time, round and/or date information associated with lottery tickets, and/or (iii) determine whether a lottery player has redeemed their lottery ticket in a manner that qualifies the player to receive a particular redemption or settlement amount.

In various example embodiments, the lottery retailer terminal 602 includes one or more output device(s). Such output device(s) may include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, the lottery retailer terminal 602 also includes one or more communications port(s), such as a serial port, a modem or the like. Generally, the communications port of the lottery retailer terminal 602 may be operable to facilitate two-way data communications between (i) the lottery retailer terminal 602, and (ii) the lottery server 606. In accordance with some embodiments, the communications port of the lottery retailer terminal 602 may operate to facilitate the transmission of information between the lottery retailer terminal and a player device such as a personal digital assistant (PDA), cell phone and/or a dedicated (e.g., a proprietary) device.

In various example embodiments, the lottery retailer terminal 602 includes a data storage device such as a hard disk, optical or magnetic media, random access memory (RAM) and/or read-only memory (ROM), or the like memory device. Generally, the data storage device of the lottery retailer terminal 602 stores a software program, the software program enabling a processor of the retailer terminal 602 to perform various functions including some or all of the various steps described herein. For example, in accordance with various embodiments, the lottery retailer terminal 602 may be configured to perform some or all of the functions of the lottery server 606 (and vice versa) such that the lottery server 606 and the lottery retailer terminal 602 may be considered as the same “device.”

In various example embodiments, a lottery sales device may be utilized in place of a lottery retailer terminal 602. Such a lottery sales device may be implemented as a lottery server, a controller, a dedicated hardware circuit, an appropriately programmed general-purpose computer, or any other equivalent electronic, mechanical or electro-mechanical device. Thus, in various embodiments, a lottery sales device may include, for example, but is not limited to: (1) a video lottery terminal that may include a touch sensitive screen for use by a player; (2) a personal computer (e.g., which communicates with a remote lottery server); or (3) a personal mobile device such as a mobile telephone, a tablet, or a personal digital assistant. The lottery sales device may include any or all of the devices of the aforementioned systems.

In this example embodiment, the lottery server 606 operates to: (1) receive and/or store data associated with one or more lottery tickets including such data as: (a) ticket identifier(s), and (b) ticket indicia; (2) determine at least a first redemption amount associated with a lottery ticket; (3) receive a redemption request associated with the lottery ticket; (4) determine a time of play associated with the redemption request; and (5) transmit an indication of the appropriate redemption amount to a lottery retailer terminal (e.g., for output or display to a lottery player and/or lottery terminal operator).

In various example embodiments, the lottery server 606 includes one or more processor(s). Such a processor functions to process instructions, and in particular, to operate in accordance with various methods described herein. For example, the processor may operate to enable the lottery server 606 to transmit data to (and receive data from) the lottery retailer terminal 602. More specifically, the processor of the lottery server 606 may enable the transmission of data representing a lottery ticket, as well as information defining one or more payout(s) associated with that lottery ticket to or by a specific one of the lottery retailer terminals 602 shown in the lottery network 600 of FIG. 3. Thus, the lottery server 606 may be implemented as a system controller, a dedicated hardware circuit, an appropriately and particularly programmed general-purpose computer, or any other equivalent electronic, mechanical or electro-mechanical device capable of providing for one or more of the embodiments described herein.

In various example embodiments, the lottery server 606 includes one or more input device(s). Examples of such input devices include a keypad, a mouse, a touch-screen, a random number generator, a microphone, and other digital or analog input devices.

In various example embodiments, the lottery server 606 also includes one or more output device(s). Example of output device(s) of the lottery server 606 include a monitor or other display for outputting information to an operator of the lottery server 606 (e.g., for displaying information such as statistical or sales data, win and loss information and/or payout amounts), a printer for producing a physical record (e.g., a report) of such data, and the like. In addition, the lottery server 606 may include one or more communications ports, such as a serial port, modem or the like, operable to facilitate two-way data communications between (i) the lottery server 606 and (ii) one or more lottery retailer terminals 602.

In various example embodiments, the lottery server 606 includes a data storage device (e.g., a hard disk or hard drive, a media-based (removable) memory, or the like). In certain embodiments, the data storage device of the lottery server 606 stores at least one software program, which includes a program to enable the processor of the lottery server 606 to perform some or all of the various steps and functions of at least one implementation of the methods described in detail herein. In addition, the data storage device of the lottery server 606 may operate to store one or more databases including a lottery ticket database and a lottery ticket redemption status database.

In various example embodiments, the lottery server 606 includes a lottery ticket server device that is located at a lottery ticket printing facility, and may also function to manage the ticket printing process. The lottery server 606 may also function to develop a lottery game matrix (e.g., determining base payouts, win frequencies, and the like) and to match static lottery content with secure paytable (or payout distribution) data. In certain embodiments, a lottery ticket printer device for use in such lottery gaming systems may utilize the game matrix information from the lottery server and may apply it to the secure paytable data.

In certain example embodiments, a retailer terminal (such as the first retailer terminal 602-1) of FIG. 3 is configured to perform some or all of the functions of the lottery server 606. Thus, in certain example embodiments, the lottery server 606 and the retailer terminal (such as the first retailer terminal 602-1) (or another given retailer terminal and server pairing) may be considered as the same “device.”

Generally, the communications network 604 of FIG. 3 includes one or more local and/or wide-area network(s) proprietary and/or public network(s) (e.g., the Internet) for facilitating two-way data communications between the retailer terminals 602 and the lottery server 606. The lottery server 606 may communicate with lottery retailer terminals 602 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices may be in communication with the lottery server 606, and communication between the lottery retailer terminals 602 and the lottery server 606 may be direct or indirect. A variety of communications protocols may be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and may actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein may be practiced on a stand-alone gaming device and/or a gaming device in communication only with one or more other gaming devices. In such an embodiment, any functions described as performed by the computer may instead be performed by one or more gaming devices.

As used herein, a lottery retailer may include a merchant who sells lottery tickets at a particular location, authenticates winning lottery tickets, redeems authenticated winning lottery tickets, and/or provides awards to players for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery gaming system comprising:
a lottery terminal; and
a central lottery server comprising a processor and a memory device that stores a plurality of instructions, that when executed by the processor, cause the processor to:
provide a lottery ticket board comprising:
different additional award symbols,
different awards associated with the different additional award symbols, and
empty additional match symbol slots; and
enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises:
a random determination of drawn symbols,
a determination of one of the additional award symbols that results in the award associated with that additional award symbol being won, and
a determination of an additional match symbol that fills one of the empty additional match symbol slots.

2. The lottery gaming system of claim 1, wherein the lottery ticket board comprises a next draw indicator, a remaining draws indicator, and a lottery ticket board code indicator.

3. The lottery gaming system of claim 1, wherein the plurality of instructions, when executed by the processor, cause the processor to provide the lottery ticket board associated with payment of a purchase price for the lottery ticket board.

4. The lottery gaming system of claim 1, wherein the lottery ticket board is associated with drawings for the draw lottery game during a predetermined time period, wherein for each said drawing, a draw lottery ticket for that drawing is linkable to the lottery ticket board.

5. The lottery gaming system of claim 1, wherein the lottery ticket board is associated with a limited quantity of drawings for the draw lottery game, wherein for each said drawing, a draw lottery ticket for that drawing is linkable to the lottery ticket board.

6. The lottery gaming system of claim 1, wherein the lottery ticket board is associated with drawings for the draw lottery game on specific dates, wherein for each said drawing, a draw lottery ticket for that drawing is linkable to the lottery ticket board.

7. The lottery gaming system of claim 1, wherein each additional match symbol that fills one of the empty additional match symbol slots is usable to match a drawn symbol for a subsequent drawing of the draw lottery game.

8. The lottery gaming system of claim 1, wherein one of the additional match symbols that fills one of the empty additional match symbol slots is usable with one of the player numbers of a subsequently purchased lottery ticket to match drawn symbols for a subsequent drawing of the draw lottery game.

9. The lottery gaming system of claim 1, wherein the determination of one of the additional award symbols that results in the award associated with that additional award symbol being won, and the determination of the additional match symbol that fills one of the empty additional match symbol slots are separate from the random determination of drawn symbols.

10. A lottery gaming system comprising:
a lottery terminal; and
a central lottery server comprising a processor and a memory device that stores a plurality of instructions, that when executed by the processor, cause the processor to:
provide a lottery ticket board comprising:
empty additional match symbol slots; and
enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises:
a random determination of drawn symbols, and
a determination of an additional match symbol that fills one of the empty additional match symbol slots.

11. The lottery gaming system of claim 10, wherein the lottery ticket board comprises a next draw indicator that indicates a date for a next drawing for the draw lottery game, wherein an additional draw lottery ticket for that next drawing is linkable to the lottery ticket board.

12. The lottery gaming system of claim 10, wherein the lottery ticket board comprises a remaining draws indicator that indicates a quantity of remaining drawings for the draw lottery game, wherein additional draw lottery tickets for the quantity of remaining drawing for the draw lottery game are linkable to the lottery ticket board.

13. The lottery gaming system of claim 10, wherein the lottery ticket board comprises a lottery ticket board code indicator that is readable to enable linking of the draw lottery ticket to the lottery ticket board.

14. The lottery gaming system of claim 10, wherein each additional match symbol that fills one of the empty additional match symbol slots is usable to match a drawn symbol for a subsequent drawing of the draw lottery game.

15. The lottery gaming system of claim 10, wherein one of the additional match symbols that fills one of the empty additional match symbol slots is usable with one of the player numbers of a subsequently purchased lottery ticket to match drawn symbols for a subsequent drawing of the draw lottery game.

16. The lottery gaming system of claim 10, wherein the determination of one of the additional award symbols that results in the award associated with that additional award symbol being won, and the determination of the additional match symbol that fills one of the empty additional match symbol slots are separate from the random determination of drawn symbols.

17. A lottery gaming system comprising:
a lottery terminal; and
a central lottery server comprising a processor and a memory device that stores a plurality of instructions, that when executed by the processor, cause the processor to:
provide a lottery ticket board comprising:
different additional award symbols, and
different awards associated with the different additional award symbols; and
enable a purchase of a draw lottery ticket for a drawing of a draw lottery game and a link of the draw lottery ticket to the lottery ticket board, wherein the draw lottery ticket comprises player numbers for the drawing of the draw lottery game, and wherein the drawing of the draw lottery game comprises:
a random determination of drawn symbols, and
a determination of one of the additional award symbols that results in the award associated with that additional award symbol being won.

18. The lottery gaming system of claim 17, wherein the lottery ticket board is associated with drawings for the draw lottery game during a predetermined time period, wherein for each said drawing, a draw lottery ticket for that drawing is linkable to the lottery ticket board.

19. The lottery gaming system of claim 17, wherein the lottery ticket board is associated with a limited quantity of drawings for the draw lottery game, wherein for each said drawing, a draw lottery ticket for that drawing is linkable to the lottery ticket board.

20. The lottery gaming system of claim 17, wherein the lottery ticket board is associated with drawings for the draw lottery game on specific dates, wherein for each said drawing, a draw lottery ticket for that drawing is linkable to the lottery ticket board.
